(19) United States
(12) Patent Application Publication
(10) Pub. No.: US 2024/0384465 A1
(43) Pub. Date: Nov. 21, 2024

(54) PIGMENT TRANSFER MATERIAL FOR TRANSFERRING AN IMAGE TO A TEXTILE SUBSTRATE

(71) Applicant: Coldenhove Know How B.V., Eerbeek (NL)

(72) Inventors: Koert Johannes SPORTEL, Eerbeek (NL); Johannes Willem Jan BANNINK, Eerbeek (NL)

(21) Appl. No.: 18/667,717

(22) Filed: May 17, 2024

(30) Foreign Application Priority Data
May 19, 2023 (NL) 2034866

(51) Int. Cl. D06P 5/28; C09D 5/02; C09D 7/61; C09D 123/06

(52) U.S. Cl. CPC D06P 5/004; C09D 5/022; C09D 7/61; C09D 123/06

(57) ABSTRACT

A pigment transfer material for transferring an image to a textile substrate and a method to transfer the image from the pigment transfer material to a textile are provided. The pigment transfer material comprises a base layer and a transfer coating.

### CROSS-REFERENCE TO RELATED APPLICATIONS

This application claims the benefit of priority under 35 U.S.C. 119(a) of Patent Application No. NL 2034866, filed May 19, 2023 in the Netherlands, the entire disclosure of which is incorporated herein by reference for all purposes.

### TECHNICAL FIELD

The present application relates to the field of pigment transfer materials. In particular, a pigment transfer material for transferring an image to a textile substrate and a method to transfer the image from the pigment transfer material to a textile are described.

### BACKGROUND

Pigment transfer materials, such as pigment transfer sheets or pigment transfer papers, are known in the field in order to provide images on textile substrates.

An example is provided in WO00/06392. Herein a transfer paper is described that is suitable for ink-jet printing. The transfer paper comprises a release or barrier layer. The transfer paper can be provided with an image using sublimation dyes. The transfer paper and method of providing the image onto a textile allows for flexibility. However, the application is generally limited to synthetic textiles due to poor binding of sublimation dyes to natural fibers.

An example that allows for providing images on natural fiber has been proposed in WO2020/256549. This pigment transfer sheet has a transfer layer and an optional release layer. An image can be printed on the transfer layer. The image can be transferred to a textile by placing the transfer layer onto the textile and applying heat and pressure. The release layer is used to ensure that at least part of the transfer layer is transferred to the textile along with the image.

WO2005/077663 describes an image transfer material comprising a support, a melt transfer layer and an image receiving layer. Printing of the receiving textile can be carried out by inkjet-printing an image on the sheet. Subsequently, the melt transfer layer and the image-receiving layer are peeled from the support layer. The melt transfer layer and image-receiving layer are placed onto a receiving textile and heat is applied to melt the transfer layer and to adhere the image to the textile. Disadvantageously, it requires the separation of the support layer from the melt layer and the image-receiving layer before appliance. This makes the approach poorly scalable. Further, this image transfer material cannot be used to print large surfaces of textile. Additionally, a plastic layer is left on the textile that results in poor ‘hand’ of the textile and poor color fastness to laundering.

In U.S. Pat. No. 5,981,077 an image transfer sheet is detailed comprising a substrate, releasing layer and an image transfer layer. The image transfer layer includes a self-crosslinkable polymer. A drawback of the transfer sheet is that the removal of the transfer sheet after printing requires low temperatures, this limits large scale applicability.

A further example is provided in U.S. Pat. No. 4,351,871. Herein a decoration material is described having a flexible substrate and a transferable layer having a thickness of at most 20 microns. The transferable layer is provided with an image and is transferred to the receiving fabric by applying heat and pressure. The applicability is however limited as printing the image is performed by gravure printing and the method requires specialty inks that are specifically prepared for the process.

The present inventors have surprisingly found a pigment transfer material and an improved process that addresses at least part of the above-mentioned drawbacks. In particular, the present inventors surprisingly found a pigment transfer material only requiring a single coating to address at least part of the above-mentioned drawbacks.

### BRIEF SUMMARY

The present disclosure concerns a pigment transfer material for transferring an image to a textile substrate and a method to transfer the image from the pigment transfer material to a textile.

In accordance with an aspect of the present disclosure, a pigment transfer material suitable for transferring an image to a texture substrate is provided. The pigment transfer material may comprise a base layer and a transfer coating. The pigment transfer material may also consist of a base layer and the transfer coating.

In some embodiments, the transfer coating can have a thickness in the range of 10 to 50 μm and/or a melting temperature in the range of 140 to 210° C.

In some embodiments, the transfer coating can have a thickness in the range of 25 to 40 μm, preferably in the range of 30 to 35 μm and/or a melting temperature in the range of 150 to 190° C., preferably in the range of 160 to 180° C.

In some embodiments, the transfer coating can be present in an amount of at least 15 g/m², preferably at least 25 g/m², preferably at least 30 g/m².

In some embodiments, the transfer coating can comprise a polyolefin, preferably a polyethylene, more preferably a low-density polyethylene (LDPE) and/or a high-density polyethylene (HDPE), most preferably HDPE.

In some embodiments, the transfer coating can comprise a softener, silica, a binder, a wetting agent, a thickener and/or an anti-foam agent.

In certain embodiments, the transfer coating comprises a softener, preferably selected from the group consisting of silicone, fatty acid, fatty amide and/or paraffin softeners

In some embodiments, the transfer coating may comprise between 50 and 100 parts by weight of the polyolefin; between 80 and 130 parts by weight of the binder; between 20 and 50 parts by weight of the softener; and between 2 and 20 parts by weight of silica. The parts by weight of the binder, softener and silica may be each individually relative to 100 parts by weight of the polyolefin.

In some embodiments, the base layer can comprise a base paper. The base paper may have a grammage between 60 g/m² and 100 g/m², more preferably a grammage between 70 g/m² and 90 g/m², most preferably a grammage between 80 g/m² and 90 g/m².

In some embodiments, the base layer may have a Cobb value between 15 and 50 g/m², more preferably a Cobb value between 20 and 40 g/m², such as about 25 g/m².

In some embodiments, the base layer may have a porosity of at most 300 ml/min, preferably at most 280 ml/min, more preferably at most 250 ml/min, as determined by ISO 5636-3.

In accordance with another aspect of the present disclosure, a process for transferring an image from a pigment transfer material to a textile substrate to provide a textile product carrying the image is provided. The process may comprise:
providing a pigment transfer material comprising a base layer and a transfer coating with a provided image of pigments on the transfer coating, preferably a pigment transfer material as previously described above;
a superimposing step comprising superimposing the pigment transfer material and the textile substrate by contacting the transfer coating with the textile substrate;
a transfer step comprising applying a pressure and heat to the superimposed contacted transfer material and textile substrate, wherein the heat is provided from a heat source facing the transfer coating; and
a peeling step comprising separating the base layer from the textile substrate and at least part of the transfer coating.

In some embodiments, the superimposed contacted transfer material and textile substrate can be heated in the transfer step to a temperature in the range of 100 to 250° C., preferably to a temperature in the range of 150 to 210° C., more preferably to a temperature in the range of 160 to 200° C., most preferably in the range of 180 to 190° C.

In some embodiments, the superimposed contacted transfer material and textile substrate can be heated in the transfer step for a time in the range of 10 to 90 seconds, preferably 15 to 60 seconds, more preferably 25 to 50 seconds, such as about 45 seconds.

In some embodiments, the base layer can be separated from the textile substrate in the peeling step at an elevated temperature, preferably at a temperature of more than 50° C., more preferably at a temperature of more than 100° C.

The process may also comprise calendering.

In some embodiments, applying said pressure provided in the transfer step may comprisee applying a surface pressure impulse, preferably a surface pressure impulse of at least 0.03 N/mm², preferably at least 0.05 N/mm², such as at least 0.06 N/mm².

In still another aspect of the present disclosure, an aqueous composition for coating a base layer to provide a pigment transfer material is provided. The aqueous composition can comprise between 50 and 100 parts by weight of a polyolefin; between 80 and 130 parts by weight of a binder; between 20 and 50 parts by weight of a softener; between 2 and 20 parts by weight of silica; and optionally a thickener, anti-foam agent and/or a wetting agent. The parts by weight of the binder, softener and silica may be each individually relative to 100 parts by weight of the polyolefin.

### BRIEF DESCRIPTION OF THE DRAWINGS

The accompanying drawings, which are incorporated in and constitute a part of this specification, illustrate several embodiments and together with the description serve to explain certain principles.

FIG. 1A provides a schematic illustration of a pigment transfer material according to the present disclosure.

FIG. 1B schematically illustrates a pigment transfer material according to the present disclosure with a printed image thereon.

FIG. 2 schematically illustrates the process for transferring an image from a pigment transfer material to a textile substrate in accordance with the present disclosure.

FIG. 3 schematically illustrates a preferred embodiment of the process in accordance with the present disclosure.

FIG. 4 schematically illustrates another preferred embodiment of the process in accordance with the present disclosure.

### DETAILED DESCRIPTION

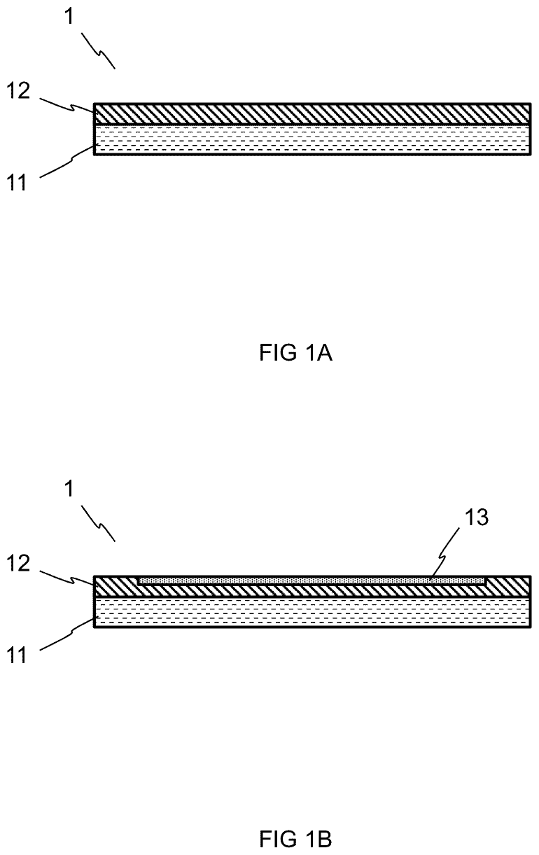

In accordance with an aspect of the present disclosure, a pigment transfer material (herein also referred to as ‘transfer material’ and ‘material’) suitable for transferring an image to a textile substrate is provided. As illustrated in FIG. 1A, the transfer material (1) comprises a base layer (11) and a transfer coating (12). “Transfer coating” and “coating” are herein used interchangeably.

The inventors further surprisingly found that the method with which the image is transferred to the textile substrate (herein also referred to as “textile” and “substrate”) can influence the transferability of an image and transfer coating to the textile. Accordingly, another aspect of the present disclosure relates to a method to transfer an image from a pigment transfer material to a textile substrate.

The transfer coating has multiple functions. Firstly, the transfer coating has the function of receiving the image, e.g. by printing. Secondly, the transfer coating has the function of facilitating the transfer of the image onto the textile substrate. Thirdly, it allows for a peeling of the base layer. To fulfill these functions, the transfer coating has a thickness in the range of 10 to 50 μm, preferably in the range of 25 to 40 μm, such as in the range of 30 to 35 μm, and/or a melting temperature in the range of 140 to 210° C., preferably in the range of 150 to 190° C., more preferably in the range of 160 to 180° C.

The melting temperature herein is used to describe the temperature at which at least a part of the coating starts to melt. The melting temperature may be determined by any suitable means in the art, for instance by providing the transfer coating on a substrate that can withstand temperatures as high as 220° C. or above and determine at which temperature the coating placed thereon starts to melt. A specific example thereof is to provide the transfer coating on a metal plate and to dry the transfer coating, followed by transferring the coating to a cotton pad and placing this in an oven. The oven is then heated stepwise from a temperature of 105° C. to 220° C., for instance with steps of 10° C. or 15° C., until the coating melts and sticks to the cotton pad.

It was found that the melting temperature of the transfer coating is particularly suitable for a transfer step (vide infra) and allows for easier peeling after the transfer step.

The thickness of the transfer coating may also be determined by any suitable means in the art. An example is to measure the thickness of the base layer before applying the transfer coating and to measure the thickness of the pigment transfer material (with the measured base layer). The thickness of the base layer is then subtracted from the thickness of the pigment transfer material to yield the thickness of the transfer coating.

It was found that part of the transfer coating is transferred along with the image to the textile. For instance between 5 and 95 wt %, preferably between 40 and 90 wt % such as about 85 wt % of the total weight of the transfer coating may be transferred along with the image to the textile. It may be appreciated that this total weight of the transfer coating is based on the dry weight of the coating. As the thickness of the transfer coating is in a particular range, the transfer of part of the coating results in a thin layer on the textile. This allows for essentially maintaining the original hand and textile properties of the textile substrate as well as allowing for a good durability of the transferred image on the textile.

Analytical methods for determining the hand of a textile exist in the art. One of these methods in the Kawabata Evaluation System (KES, see also Harwood et al. Journal of the Society of Dyers and Colourists 106 (2008) 64-68). Alternatively, the hand can be tested in a Fabric Touch Tester (FTT™M293) as described in U.S. Pat. No. 6,601,457 and commercially available from SDL Atlas LLC, USA, and carried out as described in Binti Haji Musa et al. (2018) Practical Considerations of the FTT Device for Fabric Comfort Evaluation Journal of Fashion Technology & Textile Engineering S4: 003 (herein abbreviated as determined by FTT). The aforementioned article by Binti Haji Musa et al. (2018) is incorporated herein in its entirety. The hand can also be determined by touch perception of a test panel of one or more experts

Generally, good transfer properties are obtained when the transfer coating is present in the transfer material in an amount of at least 15 g/m², based on the dry weight of the coating. Better results were obtained for more transfer coating, therefore at least 25 g/m² is preferably present, more preferably at least 30 g/m². Typically, the coating is present in less than 60 g/m², such as less than 50 g/m² or less than 40 g/m². The best results were obtained when the transfer coating is present in an amount of about 30 g/m².

Typically, a total amount of coating between 50 and 90 g/m², such as between 60 and 80 g/m² is applied in its wet state in order to obtain a desired dry weight as detailed above. The transfer coating may be applied in a single coating step. The manufacturing of the pigment transfer material according to the present disclosure is therefore relatively easy. It may however be appreciated, that the coating may also be applied in multiple separate steps. This could be beneficial for systems that do not allow the application of the total amount of coating in a single step. Typically, the material used (i.e. the composition of the transfer coating) is essentially identical (e.g. more than 95%, such as more than 98% identical) in each of the coating steps, to provide the transfer coating. The manner in which the coating is applied is not particularly limiting. The coating may for instance be applied using conventional coating manners, such as by roll coating.

It may be appreciated that the pigment transfer material may consist of the base layer and the transfer coating. Accordingly, there is no need for an additional layer between the base layer and the transfer coating and/or on top of the transfer coating. Particularly, the transfer coating may be a single coating layer. The single coating layer of the transfer coating may be obtained by a single coating step. However, the single coating layer of the transfer coating may also be obtained by multiple coating steps. As long as the material used (i.e. the composition of the transfer coating) is essentially identical in each step, it is considered a single coating layer for the purpose of the disclosure.

The transfer coating may partly transfer to the textile and allow for easier peeling after a transfer step. The present inventors found that this may be achieved by providing a polyolefin in the transfer coating. The presence of a polyolefin in the transfer coating is preferred when the pigment transfer material comprises the transfer coating as a single coating layer, and the pigment transfer material does not comprise a release layer. The polyolefin typically melts at a temperature suitable for a transfer step (vide infra) and may thus enable the release of part of the transfer coating. Further, the meltability of the polyolefins typically allows for the transfer material being usable as a so-called hot-peel material, meaning that after the transfer step, the base layer is separable from the textile product at an elevated temperature (vide infra).

Accordingly, the transfer coating preferably comprises a polyolefin. Typical examples of polyolefins include polyethylene (PE), polypropylene and polybutylene. For the present disclosure, the polyolefin preferably comprises a polyethylene. Polyethylene may be classified based on its molecular weight and branching. Types of polyethylene include low density polyethylene (LDPE), high density polyethylene (HDPE), linear low-density polyethylene (LLDPE) and ultra-high molecular weight polyethylene (UHMWPE). Preferably the transfer coating comprises a low-density polyethylene (LDPE) and/or a high-density polyethylene (HDPE). The best results were obtained for HDPE. HDPE is accordingly most preferred.

The transfer coating may further comprise one or more components that allow for i.a. better printability, dying capacity and shelf life. Printability is herein used to indicate the adherence of the pigment, ink or dye of an image to the transfer coating. The drying capacity is used to describe how fast the pigment, ink or dyes of the image dry after being applied to the transfer coating. The further components include one or more of a softener, silica, a binder, a wetting agent, a thickener and/or an anti-foam agent. Typically, the transfer coating is based on an aqueous solution comprising the one or more components and/or the polyolefin. More preferably, the transfer coating is based on an aqueous solution comprising a polyolefin, a softener, silica, a binder a wetting agent and a thickener. Accordingly, the transfer coating preferably comprises the one or more components and/or the polyolefin. More preferably, the transfer coating comprises a polyolefin, a softener, silica, a binder, a wetting agent and a thickener.

Softeners may contribute to an improved hand. For instance, the drape of the textile may be improved. In addition, softeners may allow for an improved printability, such as a reduced tendency of the ink to bleed. A further advantage of using a softener is that is allows for an improved transfer of the coating to the textile. For example, the pressure needed for transfer may be reduced. Also, softeners were found to result in a reduced peel force required to remove the transfer material from the textile substrate after transfer. The use of softeners may also result in improved crockfastness of the print.

Suitable softeners may be based on silicones such a polysiloxanes, fatty acids, fatty amides and/or paraffin. It may be favorable to use a silicon-based softener as the softener. A silicon-based softener may advantageously be employed to allow for the hand of the printed textile to remain as close to the original feel of the textile. Silicon-based softeners are known in the art (see e.g. Islam M et al. American Journal of Polymer Science & Engineering 2014, 3:129-138). Silicon-based softeners may be based on i.a. polydimethylsiloxane, amido-functional silicones, amino-functional silicones, methyl hydrogen silicones, epoxy functional silicones, hydroxy functional silicones, silicone polyether and epoxy polyether silicones and any combination thereof.

The presence of the softener in the transfer coating may have an influence on the surface properties of the pigment transfer material. Although the presence of the softener is preferred for an improved hand, it should not be detrimental to the printability of the pigment transfer material. For good printability, total free surface energy of the pigment transfer material as measured on the transfer coating face is preferably between 50 and 100 mN/m, more preferably between 60 and 90 mN/m, even more preferably between 70 and 80 mN/m, as determined according to ISO 19403-2:2017, using CH₂I₂ and water. If the total free surface energy is too low, the wetting of the ink may not be sufficient, whereas if the total free surface energy is too high, the sharpness of the print may be reduced. Notably, by using the softener in accordance with the present disclosure, and in particular the silicone-based softener, a total free surface energy of the pigment transfer material can be maintained in these ranges.

In addition, it was found that for good printability, the gloss level of the pigment transfer material, as determined on the transfer coating face at an angle of 85° according to DIN EN ISO 2813-2015-02 is preferably below 3 GU, more preferably between 1.2 and 2.5 GU, even more preferably between 1.4 and 2.0 GU, most preferably between 1.4 and 1.9 GU. Also preferably, the smoothness of the pigment transfer material as determined on the transfer coating face using a Gurley tester (standard pressure) according to ISO 5636/5 is preferably above 400 s, more preferably between 450 and 900 s, even more preferably between 500 and 720 s.

The silica (silicon dioxide, SiO₂) may be used to reduce blocking. Blocking is a term known in the art to describe stickiness of the coating. Silica may further be used to increase the shelf life of the transfer materials.

The optional binder is added to allow for i.a. a good binding of the textile to the transfer material as well as for good binding of the transfer coating to adhere to the base layer. Additionally, the binder may allow for an improved color fastness against laundering of the image on the textile. Color fastness to laundering is a measurement of i.a. the color characteristics and can be determined by the ISO Test Method 105A2:1993. A further advantage of using a binder is that it allows for a better printability and faster drying. Suitable binders may include polyurethanes, such as cationic polyurethanes, polyacrylates, carboxymethyl cellulose, hydroxyethyl cellulose, polyvinyl acetate and/or poly (vinyl alcohol). In particularly advantageous embodiments, at least two binders are used. Accordingly, it is most preferred that a combination of polyurethane and poly (vinyl alcohol) is employed. This is particularly beneficial as for instance, polyvinyl alcohols may provide for the printability and drying properties, while the polyurethanes may provide for the color fastness against laundering.

A wetting agent may be used to allow for the polyolefins to be dispersed in an aqueous environment. The wetting agent may also be referred to as a surfactant. Typically, surfactants are amphiphilic, i.e. compounds with both a hydrophobic tail and a hydrophilic head. Suitable surfactants are known in the art and may include nonionic wetting agents. Examples of suitable surfactants include ethoxylates and copolymers thereof, acrylamide polyglycol and the like.

The thickener is typically applied to increase the viscosity of the aqueous solution that the transfer coating is based on. A higher viscosity may be beneficial for applying the transfer coating on the base layer. Suitable thickeners include carboxymethyl cellulose, polyurethane, polyacrylates and/or starch.

The anti-foam agent (also referred to as defoamer) is typically employed to remove excess of foam during coating preparation. Anti-foam agents are known in the art and suitable examples include soaps, mineral oils, fatty alcohols and/or paraffin waxes. Good results were obtained for a transfer coating comprising:
between 50 and 100 parts by weight of the polyolefin;
between 80 and 130 parts by weight of the binder;
between 20 and 50 parts by weight of the softener;
between 2 and 20 parts by weight of silica; and
optionally one or more of a thickener, an anti-foam agent, a wetting agent.

The weights by parts of the binder, softener, silica, are each individually relative to 100 parts by weight of the polyolefin (based on the dry weights). The thickener, anti-foam agent and wetting agent are typically present in a total amount (i.e. the sum of the amounts of the thickener, anti-foam agent and wetting agent) between 60 and 80 parts by weight relative to 100 parts by weight of the polyolefin. For instance, the thickener may be present in an amount between 1 and 8 parts by weight, the anti-foam agent between 1 and 8 parts by weight and/or the wetting agent between 50 and 70 parts by weight, each relative to 100 parts by weight of the polyolefin.

Even better results were obtained for a transfer coating comprising:
between 80 and 100 parts by weight of the polyolefin;
between 100 and 120 parts by weight of the binder;
between 25 and 35 parts by weight of the softener;
between 10 and 20 parts by weight of silica; and
optionally one or more of a thickener, an anti-foam agent, a wetting agent.

The weights by parts of the binder, softener, silica, are each individually relative to 100 parts by weight of the polyolefin (based on the dry weight). The thickener, anti-foam agent and wetting agent are preferably present in a total amount between 65 and 75 parts by weight relative to 100 parts by weight of the polyolefin. For instance, the thickener may be present in an amount between 2 and 6 parts by weight, the anti-foam agent between 2 and 6 parts by weight and/or the wetting agent between 55 and 65 parts by weight, each relative to 100 parts by weight of the polyolefin.

According to still another aspect of the disclosure, an aqueous composition for providing a transfer coating on a base layer to obtain a pigment transfer paper is provided. This aqueous coating accordingly comprises water and the components as mentioned for the transfer coating, preferably in the same amounts as detailed above for the coating.

Favorably, the transfer material, in particular the transfer coating, allows for quick drying of an image that is provided on the coating. The pigment transfer material may be provided with an image on the transfer coating, e.g. by printing. This is exemplified in FIG. 1B, wherein the pigment transfer material (1) comprising a base layer (11) and a transfer coating (12) has an image (13). Typically, the image is touch dry before take up of the printed roll. In other words, the drying capacity of the pigment transfer material is typically sufficient, that continuous printing on the pigment transfer material may be achieved without ink set off while the printed pigment transfer material is rolled up.

Whether the image is touch dry and accordingly the drying capacity of the pigment transfer material can be determined by following method:
Print an image with the color black (K) with 10, 20, 30, 40, 50, 60, 70, 80, 90 and 100% ink coverage. This corresponds to 0.36; 0.80; 1.42; 2.14; 2.94; 4.08; 5.23; 6.67; 8.57 and 11.54 ml/m² of ink (i.e. the ink level). The used inks are Digistar K-Choice 4.0 from Kiian.
Directly after printing has completed, start a timer
After 5 minutes, cover at least the test image of the printed pigment transfer material with a 80 g/m² grammage copier paper (Canon Orange Label Performance A4 80 g/m² white).
Press the copier paper to the printed pigment transfer material by rolling three times with a roller of 10 kg on the copier paper covering the test image. It is noted that the roller should be of a sufficient size to roll over the entire surface area of the printed test image.
Separate the copier paper from the printed pigment transfer material
Determine, e.g. by eye, if any ink has transferred from the printed pigment transfer material to the copier paper
The ink level with no ink setoff is the drying capacity of the pigment transfer material. The drying capacity is recorded in ml/m² after 5 minutes drying.

Preferably, the drying capacity of the pigment transfer material is between 0.5 ml/m² and 8 ml/m² after 5 minutes of drying.

The base layer is typically a base paper layer. Preferably the base layer is cellulose based. The open structure of the base layer such as paper contributes positively to the drying time of printed images, which is particularly important for water-based inks. For this reason, a base paper layer is preferred over polymer film layers. Typical base papers are papers having a grammage between 60 g/m² and 100 g/m², more preferably a base paper having grammage between 70 g/m² and 90 g/m², most preferably a base paper having a grammage between 80 g/m² and 90 g/m². Most often, a base paper of approximately 85 g/m² is used, as this may allow for a sufficiently strong paper.

The base paper may comprise soft and/or hard wood fibers and additionally one or more fillers, sizing agents, wet strength and dry strength agents, retention aids and starch.

The base layer, in particular the base paper, can also be characterized by a Cobb value. This value provides information on the capacity to absorb water. The Cobb value can be determined by a test that measures the amount of water that is taken up by a defined area of a paper by one-sided contact with water over a period of time. It may be determined according to ISO 535, such as ISO 535:2014 or ISO 535:2023. Preferably the base layer has a Cobb value between 15 and 50 g/m², more preferably a Cobb value between 20 and 40 g/m², such as about 25 g/m².

Another characteristic of the base layer is the porosity. The porosity is preferably at most 300 ml/min, preferably at most 280 ml/min, more preferably at most 250 ml/min. The porosity is herein indicated as Bendtsen porosity and is as determined by ISO 5636-3. Typically, the pigment transfer material has a negligible porosity (e.g. porosity of at most 5 ml/min, or even 0 ml/min).

The transfer material can be used to provide a textile substrate with an image. The textile may be synthetic or based on natural fibers or blends thereof. Examples of natural fibers on which the textile can at least partially be based include cotton, viscose, silk, coir, flax, hemp, jute, ramie, sisal, mohair, cashmere, camel hair and wool or combinations thereof. Synthetic textiles may for instance be nylon-based, spandex and/or elastane-based textiles. Preferably, the textile is based on cotton or viscose, more preferably cotton.

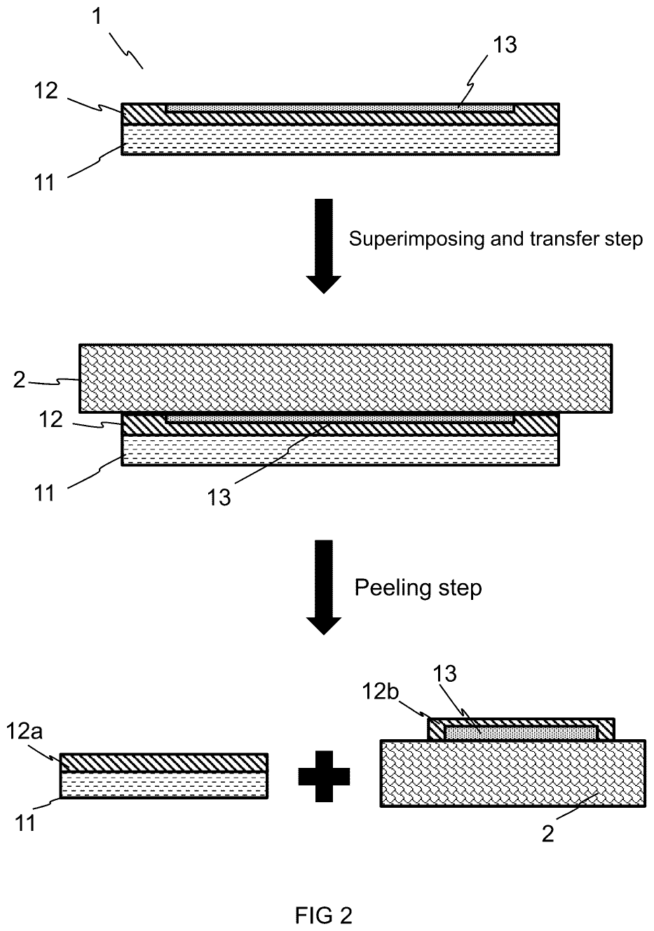

The method to accomplish the transfer of the image from the transfer material to the textile is illustrated in FIG. 2. The method comprises providing a pigment transfer material (1) comprising a base layer (11) and a transfer coating (12) with a provided (e.g. printed) image (13) of pigments on the transfer coating. The pigment transfer material is preferably as detailed above. Subsequently, a superimposing step comprising superimposing the pigment transfer material and the textile substrate by contacting the transfer coating with the textile substrate (2). The method further comprises a transfer step comprising applying a pressure and heat to the superimposed contacted transfer material and textile substrate. In this transfer step, the heat is provided from a heat source facing the transfer coating. This step is followed by a peeling step comprising separating the base layer from the textile substrate and at least part of the transfer coating. As detailed above, at least part of the transfer coating, such as top layer (12b), transfers along with the image and at least part of the transfer coating, such as a bottom layer (12a), remains on the base layer.

It was found that supplying heat from a heat source facing the transfer coating allows for a more sufficient transfer. Without wishing to be bound by theory, it is believed that a small temperature gradient forms within the transfer coating. The temperature of the part of the transfer coating closest to the heat source may be slightly higher than the temperature of the part of the transfer coating further away. Accordingly, the part closest to the heat source may be slightly more melted and thereby easier to transfer to the textile substrate. The temperature gradient may allow for the bottom layer of the transfer coating to remain attached to the base layer, while releasing the top layer of the transfer coating.

The heat that is applied during the transfer step is typically such that the superimposed contacted transfer material and textile substrate are heated to a temperature of in the range of 100 to 250° C. Some textile substrates may not be sufficiently heat resistance to temperatures above 220° C. or 210° C. For instance, pure cotton may turn slightly yellow at such temperatures. Accordingly, it may be preferred that the temperature is in the range of 150 to 210° C. The transfer coating allows for good results at a temperature in the range of 160 to 200° C. The most preferred range is between 180 to 190° C. The textile substrates are typically sufficiently resistant to these temperatures, the transfer coating is sufficiently meltable at these temperatures to allow for transfer of the image and the temperatures are typically easily executed in industrial settings.

The pressure that is applied during the transfer step may be a surface pressure, for instance a pressure of at least 0.40 bar or at least 0.50 bar. With surface pressure is herein meant the amount of pressure that is applied to the surfaces of the superimposed pigment transfer material and the textile substrate. In the field is often referred to set pressure (i.e. the pressure setting indicated by the apparatus providing the pressure). It may however be appreciated that the set pressure does not always equal the surface pressure, and conversion is typically required.

The pressure may be delivered using various means. One example includes a heat press. As detailed above, the pressure as set on the heat press may not be equal to the surface pressure actually exerted onto the superimposed transfer material and the textile substrate. For instance, depending on the heat press, a pressure may be set in the range of 1 to 100 bar, but this pressure generally concerns the pressure that is exerted onto a cylinder that is driving the pressure plates. Since these pressure plates have a much larger surface that the cross-section of the cylinder, the set pressure does not equal the surface pressure (i.e. the pressure exerted onto the superimposed material and substrate by the pressure plates). Accordingly, the set pressure can be converted into the surface pressure using the respective surface areas. The surface pressure can also be determined by using analytical techniques such as pressure papers or pressure sensors.

A particular advantage of the pigment transfer material and the process according to the present disclosure, is that the transfer step (i.e. applying pressure and heat to the superimposed contacted transfer material and textile substrate) can be carried out using calendering. Calendering conditions which result in excellent transfer results in terms of degree and quality are similar as in WO2020/256549, which is incorporated herein in its entirety. Calendering enables continuous processing, processing of textile substrates having large surface areas and good control over the process parameters. As such, calendering is ideally suited for large scale processes.

In the calendering of the present process, any type of calender can be used as long as it can provide the desired transfer step conditions (e.g. sufficient temperature, pressure and dwell time). Preferred calenders are for instance a lamination calender and a regular transfer calender. Regular transfer calenders are conventionally used for sublimation transfer, while lamination calender (also referred to as coating calender or laminating and coating calender) are conventionally used to laminate or coat textiles such as non-wovens. Such calenders are for instance commercially available from Klieverik Heli BV, the Netherlands and Monti Antonio S.p.A., Italy. For the present disclosure, the lamination calender is particularly preferred as it can readily provide sufficient pressure to obtain good transfer results by equipping the calender with lamination cylinders. However, a regular transfer calender adjusted to provide sufficient pressure is also highly preferred, since this would alleviate the requirement of providing two types of calenders for sublimation transfer and transfer according to the present disclosure.

When calendaring is used in the process according to the present disclosure, the pressure applied during the transfer step may be expressed by the set pressure (vide infra), which is a pressure that is indicated by the calender apparatus. The set pressure however, typically does not directly equal the amount of pressure that is actually exerted onto the transfer material and the textile substrate (herein referred to as the surface pressure). In the field, calender pressures during sublimation transfer are for instance typically set in the range of 2 to 10 bar, but the pressure exerted directly to the transfer material and textile substrate i.a. depends on the size of the cylinders used and therefore generally does not equal the set pressure but is generally much lower. However, taking into account the contact surface area, the set pressure can be converted into the surface pressure. Besides influencing the set pressure, the surface pressure during the transfer step can also be increased by providing a web sheet, that is fed through the calender together with the superimposed pigment transfer material and the textile substrate. The web sheet has a thickness which results in an increased pressure on the superimposed pigment transfer material and the textile substrate and improved results in terms of transfer degree and quality.

Although the surface pressure may play a role in the transfer results, even better results may be obtained with a pressure impulse. Such a pressure impulse, for instance a surface pressure impulse, may be provided by lamination cylinders. In particular, good transfer results may be obtained when the transfer step comprises the pressure impulse introduced at the beginning of the transfer step. With pressure impulse is meant a temporary increase in pressure compared to the surface pressure provided during at least part of the transfer step in the dwell time window (i.e. the time during which the superimposed contacted transfer material and textile substrate are heated and pressed to achieve sufficient transfer). Preferably, the pressure impulse is provided within the first half of the dwell time, more preferably within the first quarter of the dwell time. The pressure impulse may be provided by means of the calender adapted to provide said pressure impulse, for instance by the aforementioned lamination cylinders. Additionally or alternatively to the pressure impulse provided by a lamination cylinder, the pressure impulse may also be provided by a feeding cylinder in the art sometimes also referred to a feed roller.

In a preferred embodiment, the surface pressure impulse is a pressure of at least 0.02 N/mm², preferably a surface pressure impulse of at least 0.03 N/mm², preferably at least 0.05 N/mm², such as at least 0.06 N/mm². It is noted that this surface pressure is not the set pressure, but the actual pressure exerted on the surface of the superimposed transfer material and the textile substrate. This surface pressure impulse typically amounts to a set pressure impulse of at least 2 bar, such as least 4 bar, or at least 6 bar. It was found that the pressure impulse of these values can compensate for a lower surface pressure that is exerted during the remaining time of applying heat and pressure (i.e. dwell time). It was found that in the embodiments wherein a pressure impulse is applied, the complementing surface pressure that is applied during the dwell time can even be lower than 0.40 bar. As such, it is possible that a conventional calender, e.g. a regular transfer calenders that is not capable of providing a constant surface pressure of 0.40 bar or higher, may nevertheless be used by equipping this calender with a cylinder adapted for providing the pressure impulse.

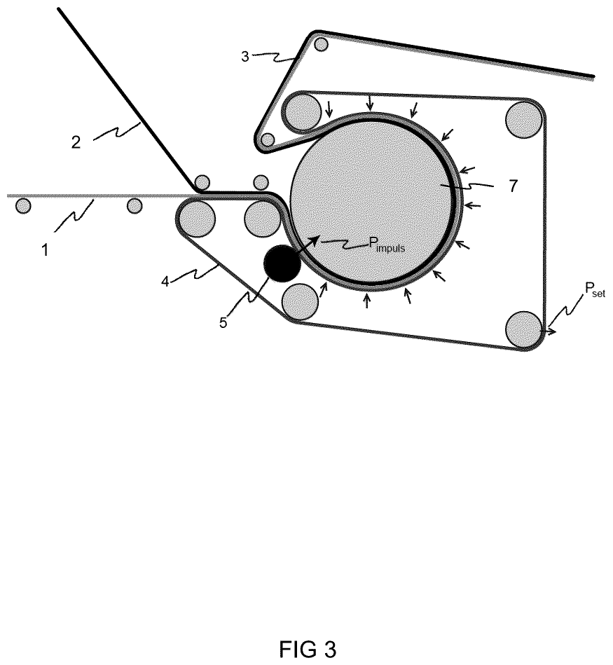

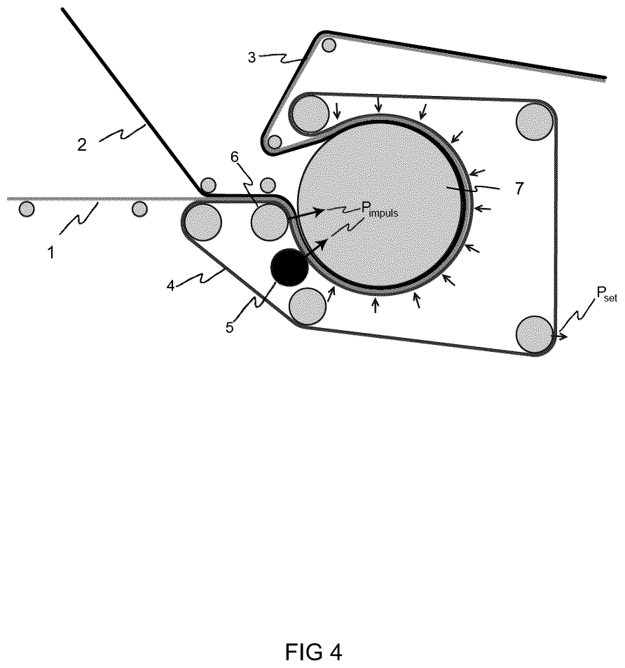

FIGS. 3 and 4 illustrate particular embodiments of the disclosure comprising calendaring with a pressure impulse. An incoming pigment transfer material (1) and a textile substrate (2) are superimposed and jointly fed to the calender, which calender comprises a felt (4) capable of providing the set pressure (Pset) in the transfer step. The calender further comprises a lamination cylinder (5) that is adapted to provide the superimposed transfer material (1) and the substrate (2) with a pressure impulse (Pimpulse). As specifically illustrated in FIG. 4, additionally or alternatively to the pressure impulse (Pimpulse) provided by the lamination cylinder (5), the pressure impulse may also be provided by the feeding cylinder (6) (in the art sometimes also referred to a feed roller). Exiting from the calendar is the textile (3) to which at least the base layer is still adhered. In a next peeling step, this base layer and part of the transfer coating may be separated from the textile to provide the textile product (not shown). It may be appreciated that in case the method comprises calendaring, that the heat may be supplied from the center cylinder (7).

Another parameter that is found to influence the transfer yield or yield (or degree of transfer) and quality of the transfer step is the time during which the superimposed contacted transfer material and textile substrate are heated and pressed (herein also referred to as dwell time). The dwell time should be sufficient to allow good transfer (both in terms of degree as in quality), but is ideally not too high as to hamper the overall process speed. A low process time is particularly preferred in high scale production, for which the present disclosure is particularly suitable. Higher process speeds increase production efficiency and reduce production cost per production line. Accordingly, the dwell time in the present process is preferably in the range of 10 to 90 seconds, more preferably 15 to 60 seconds, most preferably 25 to 50 seconds such as about 45 seconds.

In the embodiments comprising the pressure impulse, the dwell time is to be understood as the entire time during which a pressure is exerted onto the superimposed transfer material and the textile substrate to achieved sufficient transfer. The time of the pressure impulse is typically much shorter, e.g. a couple of seconds such as about 0.5 to 5 seconds. If the surface pressure exerted during the pressure impulse is sufficiently high, such a short time is sufficient, in particular in combination with the pressure exerted during the remaining dwell time.

The peeling step is preferably carried out within seconds, e.g. within 20 seconds, more preferably within 10 seconds. The base layer is preferably separated from the textile substrate at an elevated temperature, most preferably at a temperature of more than 50° C., most preferably at a temperature of more than 100° C. As such, the peeling step is preferably a hot-peeling step. Hot-peeling is particularly advantageous for continuous processes and for use with the calendering as it enables a fast throughput of the textile substrate and pigments transfer material. A cold-peel step would require intermediate cooling of the superimposed material and substrate after the transfer step, which would either require a long time period or active cooling. Neither is preferred.

With the peeling step, the base layer is separated from the textile substrate and at least part of the transfer coating. When the transfer efficiency is maximum, all intended parts of the transfer coating and the image printed thereon are transferred to the textile substrate.

The image of pigments can be printed on the pigment transfer material by various methods. The disclosure is not limited to a specific printing method, although a preferred method may comprise inkjet printing. The disclosure is further not limited to a specific type of pigment or ink, as the binding to the textile may be carried out by the transfer coating, and not by the pigment or ink itself. However, the use of self-binding and/or reactive pigments is not excluded and may in some embodiments even be preferred, in particular if a long-lasting and/or highly-durable textile product is desired. A combination of binding by both the transfer coating and the ink itself, may provide extra-ordinary durability. Accordingly, a sublimation dye may also be used in particular embodiments, especially when such sublimation dye binds particularly well to the textile substrate by themselves. Other inks that may suitably be used include latex inks and UV-curable inks (see for example Stephen Hoath, Fundamentals of Inkjet Printing, Wiley-VCH 2016). General inkjet inks, latex inks, UV-curable inks and sublimation inks are all printable with inkjet printing. These inks are therefore preferred over inks or colorants that cannot be printed with inkjet printing.

As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features.

For the purpose of clarity and a concise description, features are described herein as part of the same or separate embodiments; however, it will be appreciated that the scope of the present disclosure may include embodiments having combinations of all or some of the features described.

The present disclosure can be illustrated using the following non-limiting examples.

### Example 1

Pigment transfer materials (papers) A-E were prepared by coating a base paper having a grammage of 85 g/m² and a Cobb value of 25 g/m² with a transfer coating using different compositions as detailed in Table 1. The transfer coatings were each individually present in about 30 g/m² (dry weight). Each of the transfer coatings individually had a melting temperature in the range of 150 to 180° C. and a thickness between 25 to 35 μm.

The coatings were made by:
Providing water
Adding the nonionic wetting agent and defoamer
Dispersing the PE pigment and silica into the water

Adding to this dispersion:
Emulsion of binder and crosslinker
Cationic PU dispersion
Thickener
Softener

TABLE 1

| | Solid | Paper A | | Paper B | | Paper C | | Paper D | | Paper E | |
|---|---|---|---|---|---|---|---|---|---|---|---|
| | content | [kg] | [kg] | [kg] | [kg] | [kg] | [kg] | [kg] | [kg] | [kg] | [kg] |
| Ingredient | [%] | Wet | Dry | Wet | Dry | Wet | Dry | Wet | Dry | Wet | Dry |
| PE pigment | 100.00 | 25.7 | 25.7 | 26.7 | 26.7 | 25.7 | 25.7 | 25.7 | 25.7 | 25.7 | 25.7 |
| (as polyolefin) | | | | | | | | | | | |
| Emulsion of | 33.5 | 41.7 | 14.0 | 28.0 | 9.4 | 21.0 | 6.8 | 0.0 | 0.0 | 83.7 | 28.0 |
| binder and | | | | | | | | | | | |
| crosslinker (as | | | | | | | | | | | |
| binder) | | | | | | | | | | | |
| Silicone | 23.9 | 33.4 | 8.0 | 34.6 | 8.3 | 33.4 | 8.0 | 33.4 | 8.0 | 33.4 | 8.0 |
| softener | | | | | | | | | | | |
| Water | 0.00 | 40.3 | 0.0 | 44.0 | 0.0 | 44.0 | 0.0 | 48.3 | 0.0 | 44.0 | 0.0 |
| PU thickener | 33.3 | 3.3 | 1.1 | 3.3 | 1.1 | 3.3 | 1.1 | 3.3 | 1.1 | 3.3 | 1.1 |
| Cationic PU | 42.0 | 33.4 | 14.0 | 47.0 | 19.7 | 50.0 | 21.0 | 66.8 | 28.1 | 0.0 | 0.0 |
| dispersion (as | | | | | | | | | | | |
| binder) | | | | | | | | | | | |
| Defoamer | 39.5 | 2.5 | 1.0 | 2.5 | 1.0 | 2.5 | 1.0 | 2.5 | 1.0 | 2.5 | 1.0 |
| Nonionic | 100.0 | 16.0 | 16.0 | 16.7 | 16.7 | 16.0 | 16.0 | 16.0 | 16.0 | 16.0 | 16.0 |
| wetting agent | | | | | | | | | | | |
| Silica pigment | 100.0% | 3.8 | 3.8 | 4.0 | 4.0 | 3.8 | 3.8 | 3.8 | 3.8 | 3.8 | 3.8 |

From the coated papers the drying capacity was determined by the following method:
An image was printed with the color black (K) with 10, 20, 30, 40, 50, 60, 70, 80, 90 and 100% ink coverage. This corresponded to 0.36; 0.80; 1.42; 2.14; 2.94; 4.08; 5.23; 6.67; 8.57 and 11.54 ml/m² of ink (i.e. the ink level). The used inks was Digistar K-Choice 4.0 from Kiian.
Directly after printing had completed, a timer was started
After 5 minutes, at least the test image of the printed pigment transfer material was covered with a 80 g/m² grammage copier paper (Canon Orange Label Performance A4 80 g/m² white).
The copier paper was pressed to the printed pigment transfer material by rolling three times with a roller of 10 kg on the copier paper covering the test image.
The copier paper was separated from the printed pigment transfer material
It was determined by eye if any ink had transferred from the printed pigment transfer material to the copier paper
The ink level with no ink setoff was recorded as the drying capacity of the paper in ml/m² after 5 minutes drying.

The results are provided in Table 2.

TABLE 2

| | Paper A | Paper B | Paper C | Paper D | Paper E |
|---|---|---|---|---|---|
| Drying capacity | 2.94 | 2.14 | 1.42 | 0.80 | 6.67 |
| (ml/m² after 5 | | | | | |
| minutes drying) | | | | | |
| Print quality | Good | Good | Poor | Poor | Excellent |
| Color fastness to | Good | Good | Good | Excellent | Poor |
| laundering | | | | | |

Textiles substrates that were obtained by transferring an image of Papers A-E had a good hand.

### Example 2

Pigment transfer materials (papers) were prepared by coating a base paper having a grammage of 85 g/m² and a Cobb value of 25 g/m² with single-layered coatings of 25 g/m² containing the following ingredients:
55 parts of polyolefin
11 parts of an emulsion of binder and crosslinker
27 parts of a cationic polyurethane binder
5 parts of silica pigment
1 part of anti-foam agent and thickener
optionally, 16 parts of softener (quaternary fatty amide or silicone based)

An image was printed on each pigment transfer material using an Epson Stylus Pro 4450 printer and Fujifilm TX440 ink. After printing, the print quality and bleeding was determined.

The image was transferred to textile substrate using a Heatjet Transfer calendar (200° C., 30 seconds, 5 bar pressure). The textile used was 100% cotton warp satin (246 g/m²). After transferring to the textile, the peel behavior was observed and the crockfastness was determined. The hand was tested by a test panel. Further, the total free surface energy, the dispersive and the polar surface energies were determined according to ISO 19403-2:2017, using CH₂I₂ and water as the liquid. The Gloss level (GU) was determined at an angle of 85° according to DIN EN ISO 2813-2015-02 and the smoothness(s) was determined using a Gurley tester (standard pressure) according to ISO 5636/5. The results are provided in Table 3.

TABLE 3

| | | Quaternary fatty | |
|---|---|---|---|
| | No softener | amides softener | Silicone softener |
| Hand | Poor | Excellent | Excellent |
| Print quality | Poor | Good | Excellent |
| Peel | Poor | Good | Good |
| Crockfastness | Poor | Good | Good |
| Total Free Surface | 74 | 66 | 75 |
| energy (mN/m) | | | |
| Dispersive surface | 50 | 79 | 48 |
| energy (mN/m) | | | |
| Polar Surface | 24 | 17 | 26 |
| energy (mN/m) | | | |
| Gloss level (GU) | 2.05 | 1.68 | 1.72 |
| Smoothness (s) | 750 | 530 | 690 |

What is claimed is:

1. Pigment transfer material suitable for transferring an image to a textile substrate, said transfer material comprising a base layer and a transfer coating, wherein said transfer coating has a thickness in the range of 10 to 50 μm and/or a melting temperature in the range of 140 to 210° C.

2. Pigment transfer material according to claim 1, wherein said transfer coating has a thickness in the range of 25 to 40 μm, preferably in the range of 30 to 35 μm and/or a melting temperature in the range of 150 to 190° C., preferably in the range of 160 to 180° C.

3. Pigment transfer material according to claim 1, wherein said transfer coating is present in an amount of at least 15 g/m², preferably at least 25 g/m², preferably at least 30 g/m².

4. Pigment transfer material according to claim 1, wherein the transfer coating comprises a polyolefin, preferably a polyethylene, more preferably a low-density polyethylene (LDPE) and/or a high-density polyethylene (HDPE), most preferably HDPE.

5. Pigment transfer material according to claim 4, wherein the transfer coating comprises a softener, silica, a binder, a wetting agent, a thickener and/or an anti-foam agent.

6. Pigment transfer material according to claim 5, wherein the transfer coating comprises a softener, preferably selected from the group consisting of silicone, fatty acid, fatty amide and/or paraffin softeners.

7. Pigment transfer material according to claim 5, wherein the transfer coating comprises:
between 50 and 100 parts by weight of the polyolefin;
between 80 and 130 parts by weight of the binder;
between 20 and 50 parts by weight of the softener; and
between 2 and 20 parts by weight of silica;
wherein the parts by weight of the binder, softener and silica are each individually relative to 100 parts by weight of the polyolefin.

8. Pigment transfer material according to claim 1, wherein the base layer comprises a base paper, preferably a base paper having a grammage between 60 g/m² and 100 g/m², more preferably a base paper having grammage between 70 g/m² and 90 g/m², most preferably a base paper having a grammage between 80 g/m² and 90 g/m².

9. Pigment transfer material according to claim 1, wherein the base layer has a Cobb value between 15 and 50 g/m², more preferably a Cobb value between 20 and 40 g/m², such as about 25 g/m².

10. Pigment transfer material according to claim 1, wherein the base layer has a porosity of at most 300 ml/min, preferably at most 280 ml/min, more preferably at most 250 ml/min, as determined by ISO 5636-3.

11. Pigment transfer material according to claim 1, consisting of the base layer and the transfer coating.

12. Process for transferring an image from a pigment transfer material to a textile substrate to provide a textile product carrying said image, said process comprising:
providing a pigment transfer material comprising a base layer and a transfer coating with a provided image of pigments on the transfer coating, preferably a pigment transfer material according to claim 1;
a superimposing step comprising superimposing the pigment transfer material and the textile substrate by contacting the transfer coating with the textile substrate;
a transfer step comprising applying a pressure and heat to the superimposed contacted transfer material and textile substrate, wherein the heat is provided from a heat source facing the transfer coating; and
a peeling step comprising separating the base layer from the textile substrate and at least part of the transfer coating.

13. Process according to claim 12, wherein the superimposed contacted transfer material and textile substrate are heated in the transfer step to a temperature in the range of 100 to 250° C., preferably to a temperature in the range of 150 to 210° C., more preferably to a temperature in the range of 160 to 200° C., most preferably in the range of 180 to 190° C.

14. Process according to claim 12, wherein the superimposed contacted transfer material and textile substrate are heated in the transfer step for a time in the range of 10 to 90 seconds, preferably 15 to 60 seconds, more preferably 25 to 50 seconds, such as about 45 seconds.

15. Process according to claim 12, wherein the base layer is separated from the textile substrate in the peeling step at an elevated temperature, preferably at a temperature of more than 50° C., more preferably at a temperature of more than 100° C.

16. Process according to claim 12, wherein said process comprises calendering.

17. Process according to claim 12, wherein applying said pressure provided in the transfer step comprises applying a surface pressure impulse, preferably a surface pressure impulse of at least 0.03 N/mm², preferably at least 0.05 N/mm², such as at least 0.06 N/mm².

18. Process according to claim 12, wherein said pressure impulse is applied within the first half time period of the transfer step, preferably within the first quarter time period of the transfer step.

19. Aqueous composition for coating a base layer to provide a pigment transfer material, said composition comprising
between 50 and 100 parts by weight of a polyolefin;
between 80 and 130 parts by weight of a binder;
between 20 and 50 parts by weight of a softener;
between 2 and 20 parts by weight of silica; and
optionally a thickener, anti-foam agent and/or a wetting agent;
wherein the parts by weight of the binder, softener and silica are each individually relative to 100 parts by weight of the polyolefin.
